(19) United States
(12) Patent Application Publication
(10) Pub. No.: US 2011/0023985 A1
(43) Pub. Date: Feb. 3, 2011

(54) Multilayer tube, particularly for industrial systems for the production and/or treatment of chemical compounds and the like

(75) Inventor: Andrea Deregibus, Padova (IT)

Correspondence Address: MODIANO & ASSOCIATI, Via Meravigli, 16, MILANO, 20123, IT

(73) Assignee: TUBIGOMMA DEREGIBUS S.R.L.

(21) Appl. No.: 12/805,209

(22) Filed: Jul. 19, 2010

(30) Foreign Application Priority Data
Jul. 29, 2009 (IT) PD2009A000228

(51) Int. Cl. F16L 55/00; F16L 11/20

(52) U.S. Cl. 138/103; 138/137

(57) ABSTRACT

A multilayer tube for industrial systems for the production and/or treatment of chemical compounds, in fluid form, comprising a plurality of layers, of which at least one internal layer forming the duct for the fluid, an electrically conducting layer external to the internal layer, and a protection and finishing layer of the electrically conducting layer which it covers, forming the outer surface of the multilayer tube.

The protection layer has a matrix made of electrically insulating material penetrated by electrically conducting bridges being discrete, mutually electrically insulated from the matrix and scattered substantially uniformly within it. The bridges are in electrical contact with the electrically conducting layer and facing the external surface to form an electrical connection between the electrically conducting layer and the outside of the multilayer tube.

The present invention refers to a multilayer tube, particularly for industrial systems for the production and/or treatment of chemical compounds and the like.

### BACKGROUND OF THE INVENTION

Nowadays, in the field of production of tubes for industrial use, antistatic tubes are well known. These are multilayer tubes that have an electrically conducting layer that forms a surface that is electrically substantially equipotential and which envelops the duct for the fluid.

In particular, such tubes are used in environments where inflammable or explosive substances are treated or used, or for their transport, in order to prevent electrical discharges induced by electrostatic accumulation owing to rubbing of the tubes during their movement or by fluids flowing in them.

During the lifetime of antistatic tubes it is possible that the electrically conducting layer degrades or breaks, so interrupting the equipotential surface and, therefore, rendering the antistatic property of the tube null.

For reasons of safety, it is therefore necessary that during the lifetime of use of an antistatic tube its electrical conductibility be verifiable.

One type of known tube has two external layers in polyethylene filled with carbon so as to be electrically conducting. Of these the outer layer, which forms the outer surface of the tube, has a substantially uniform dispersion of portions in non-electrically conducting polyethylene, whitish in colour.

To verify the electrical conductibility of a tube of this type, two sections, for example at opposite ends, are connected by means of terminals to a device for measuring conductibility.

If no electrical potential difference is found between the two sections, or a potential difference is found that is not higher than a predefined tolerance threshold, this means that there is sufficient electrical conductibility to guarantee the safety of use of the tube, which therefore does not need to be replaced.

A pressing requirement in the field of production of antistatic tubes nowadays is to enable an easy and effective connection of the electrically conducting layer with a device for detecting its state, such connection needing to be able to be set up easily and substantially at any section of the tube, through its surface layers.

Furthermore, a very pressing requirement in the use of antistatic tubes, particularly in production plants of pharmaceutical and/or cosmetic products, is that such tubes are light in colour in order to allow cleaners to easily identify where they may be dirty, moreover giving the environment an aspect of cleanliness that dark-coloured tubes do not convey.

However, the type of tube described is substantially dark in colour, because its appearance is heavily influenced by the fact that the polyethylene filled with carbon gives it a typically blackish colouring.

### SUMMARY OF THE INVENTION

The aim of the present invention is to provide a multilayer tube that satisfies the cited requirements by overcoming the drawbacks of the products currently known, so making it possible to obtain a tube that is light in colour and which allows an easy verification of its antistatic property.

Within this aim, an object of the invention is to devise a multilayer tube that is at least predominantly white or whitish.

Another object of the invention is to offer a multilayer tube that allows an easy electrical connection of its internal, conducting layer to a device to assess its conductibility, to be connected externally to the tube.

A further object of the invention is to offer a multilayer tube that is structurally simple and easy to use, and which can be produced at low cost.

This aim, as well as these and other objects which will become better evident hereinafter, are achieved by a multilayer tube, particularly for industrial systems for the production and/or treatment of chemical compounds and the like, in fluid form, comprising a plurality of layers of which at least
one internal layer, which forms the duct for the fluid,
an electrically conducting layer which is external to such internal layer, and
a protection and finishing layer of such electrically conducting layer that it covers, forming the outer surface of such multilayer tube,

characterized in that such protection and finishing layer has a matrix made of electrically insulating material that is penetrated by electrically conducting bridges, such bridges being discrete and scattered substantially uniformly within such matrix, which separates them, isolating them electrically from each other, with respect to the protection layer, such bridges being further in contact with such electrically conducting layer and facing such external surface so as to form on such external surface points for electrical connection to such electrically conducting layer.

### BRIEF DESCRIPTION OF THE DRAWINGS

Further characteristics and advantages of the invention will become better apparent from the description of a preferred, but not exclusive, embodiment of the multilayer tube according to the invention, illustrated, by way of a non-limiting example, in the accompanying drawings, wherein:

FIG. 1 shows a section of tube, according to the invention, in plan view;

FIG. 2 shows an enlarged detail of a multilayer tube, according to the invention, in a transverse sectional view;

FIG. 3 shows a detail in sectional view of a multilayer tube, according to the invention, taken along the dotted line in FIG. 2.

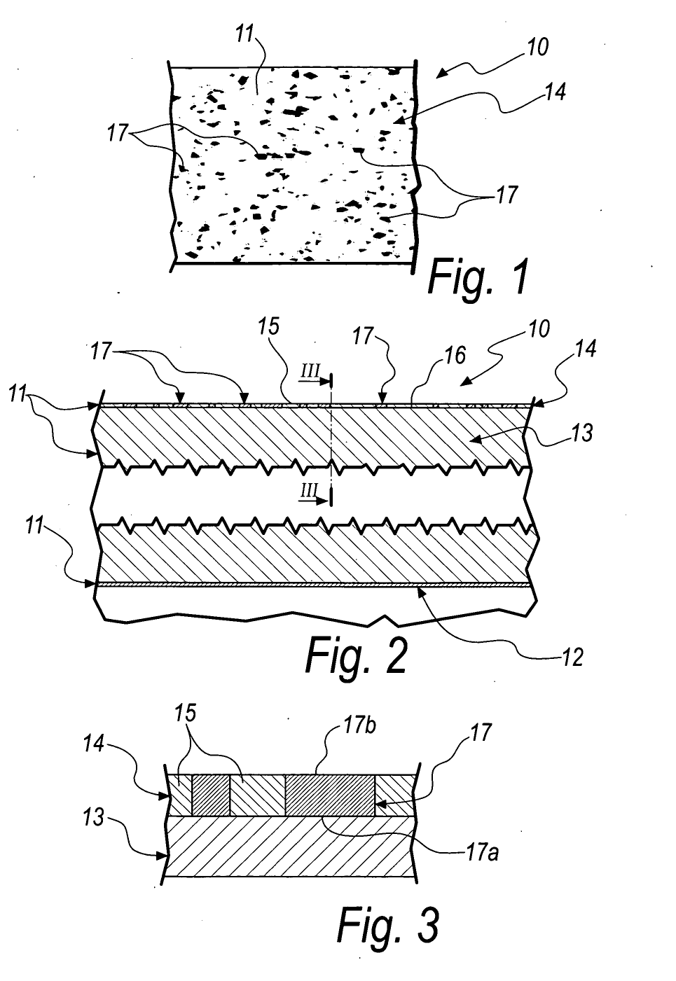

### DESCRIPTION OF THE PREFERRED EMBODIMENTS

It should be noted that everything that, in the course of the procedure of obtaining the patent, should be found to be prior art, is not intended to be claimed and is intended to be removed from the claims.

With reference to the figures, the reference numeral 10 refers globally to a multilayer tube, particularly for industrial systems for the production and/or treatment of chemical compounds and the like, in fluid form, comprising a plurality of layers 11 of which at least
one internal layer 12 which defines a duct for the fluid, preferably made of silicon or a suitable polymer, selected according to the fluid being handled, such as, for example, polytetrafluoroethylene,
an electrically conducting layer 13, and
a protection and finishing layer 14 of the electrically conducting layer 13 which it covers.

The protection and finishing layer 14 forms the outer surface 15 of the multilayer tube 10.

According to the invention, the multilayer tube 10 has a particular distinctive feature in that the protection and finishing layer 14 has a matrix 16 that is made of electrically insulating material and which is penetrated by bridges 17 which are electrically conductive.

The bridges 17 are discrete and are dispersed substantially uniformly within the matrix 16 which separates them and isolates them electrically from each other within such matrix.

The bridges 17, furthermore, at one end 17a of their ends are in contact, specifically electrical contact, with the electrically conducting layer 13, the second end 17b facing the external surface 15 so as to define points or regions for electrical connection on the external surface 15.

In this way, the bridges 17 constitute an electrical connection between the electrically conducting layer 13 and the external surface 15.

Advisably, the bridges 17 can equivalently
adhere to the electrically conducting layer 13, at their first end 17a, and/or
be fused with the electrically conducting layer 13, substantially to constitute a single body.

Furthermore, the bridges 17 and the electrically conducting layer 13 are preferably made of thermoplastic polymeric material that is filled with conductive particles, advantageously carbon.

The matrix 16 is advisably made of thermoplastic polymeric material which can be, according to the contingent requirements, the same thermoplastic polymeric material used to make the bridges 17 and the electrically conducting layer 13, or a different thermoplastic polymeric material.

Advantageously, the matrix 16, the bridges 17 and the electrically conducting layer 13 are made of the same thermoplastic polymeric material which advisably is polyethylene and, in particular, preferably is ultrahigh molecular weight polyethylene, also known by the acronym UHMWPE.

In addition, the matrix 16 has advisably a light colour shade with respect to the bridges 17 and, in particular, it is conveniently white or whitish.

The protection and finishing layer 14 advantageously has its outer surface 15 substantially smooth and glossy, so that the multilayer tube 10 has a strong tendency to remain clean and is also easy to clean, by contrasting the adhesion, upon it, of the dust or dirt with which it may come into contact.

Moreover, with its smooth external surface 15, the multilayer tube 10 slides easily, offering easy installation and moving.

To verify the antistatic nature of the multilayer tube 10 according to the invention, the checking terminals of a device to assess electrical conductibility can be attached to the ends.

These terminals, by engaging with the external surface 15 of the multilayer tube 10, define an electrical contact with the bridges 17, which are dispersed within the matrix 16, so creating an electrical connection with the electrically conducting layer 13.

By means of such device, it is thus possible to detect whether the electrical conductibility, of the multilayer tube 10, is within the prescribed tolerances.

Moreover, if such device finds an insufficient level of electrical conductibility, it is possible to identify a section of the conductive layer that has been damaged by moving one of the checking terminals along the multilayer tube 10, towards the other terminal.

In this way, the damaged section can be located based on the position of the moved terminal, in proximity to which the device finds a level of conductibility that falls within the limits that can be ascribed to a state of acceptable electrical conductibility of the multilayer tube 10.

In practice it has been found that the invention fully achieves the intended aim and objects by providing a multilayer tube that makes it possible to satisfy the above mentioned requirements and to overcome the drawbacks of the products known today, by being light in colour because the colour of its surface is determined by the colour of the matrix that dominates chromatically.

Furthermore, a multilayer tube according to the invention makes it possible to easily verify the effectiveness of its antistatic nature, as described.

A multi-layer tube according to the invention also allows an easy electrical connection of its internal, conducting layer to a device to assess its conductibility, to be connected externally to the tube by means of the electrically conducting bridges that penetrate the protection and finishing layer of the conducting layer.

Also, a multilayer tube according to the invention is structurally simple, easy to make, and can be made at relatively low cost.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the dimensions and the contingent shapes, may be any according to requirements and to the state of the art.

The disclosures in Italian Patent Application No. PD2009A000228 from which this application claims priority are incorporated herein by reference.

What is claimed is:

1. A multilayer tube for industrial systems for the production and/or treatment of chemical compounds in fluid form, comprising
at least one internal layer, which forms the duct for the fluid;
at least one electrically conducting layer which is external to said internal layer, and
at least one layer for protection and finishing of said electrically conducting layer that the at least one protection layer covers, so as to form an outer surface of the multilayer tube, and wherein said at least one protection and finishing layer comprises a matrix made of electrically insulating material that is penetrated by electrically conducting bridges, said bridges being discrete and scattered substantially uniformly within said matrix, said bridges being separated and isolated electrically from each other by said matrix with respect to the at least one protection layer, said bridges being furthermore in contact with said at least one electrically conducting layer and facing said external surface so as to form on said external surface points for electrical connection to said at least one electrically conducting layer.

2. The multilayer tube of claim 1, wherein said bridges are selected among
bridges that are suitable to adhere to said at least one electrically conducting layer, and
bridges that are suitable to be fused with said at least one electrically conducting layer.

3. The multilayer tube of claim 2, wherein said bridges and said at least one electrically conducting layer are made of thermoplastic polymeric material filled with conducting particles.

4. The multilayer tube of claim 1, wherein said matrix is made of thermoplastic polymeric material.

5. The multilayer tube of claim 4, wherein said thermoplastic polymeric material is polyethylene.

6. The multilayer tube of claim 4, wherein said thermoplastic polymeric material is ultrahigh molecular weight polyethylene, in acronym UHMWPE.

7. The multilayer tube of claim 3, wherein said conducting particles are made of carbon.

8. The multilayer tube of claim 1, wherein said matrix has a light colour shade with respect to said bridges.

9. The multilayer tube of claim 8, wherein said matrix is substantially white.

10. The multilayer tube of claim 1, wherein said at least one protection and finishing layer has said outer surface 15 substantially smooth and glossy.

11. The multilayer tube of claim 3, wherein said thermoplastic material is polyethylene, preferably ultrahigh molecular weight polyethylene, and said conducting particles are made of carbon.
